(19) United States
(12) Patent Application Publication
(10) Pub. No.: US 2022/0180418 A1
(43) Pub. Date: Jun. 9, 2022

(54) COCKTAIL PROPOSAL APPARATUS, COCKTAIL PROPOSAL METHOD, AND NON-TRANSITORY COMPUTER READABLE MEDIUM

(71) Applicant: NEC Corporation, Tokyo (JP)

(72) Inventors: Takashi MARUYAMA, Tokyo (JP); Kozo SATODA, Tokyo (JP); Takayuki KURODA, Tokyo (JP); Yutaka YAKUWA, Tokyo (JP); Takuya KUWAHARA, Tokyo (JP); Tatsuya FUKUDA, Tokyo (JP); Kazuki TANABE, Tokyo (JP)

(73) Assignee: NEC Corporation, Tokyo (JP)

(21) Appl. No.: 17/542,661

(22) Filed: Dec. 6, 2021

(30) Foreign Application Priority Data
Dec. 9, 2020 (JP) 2020-203907

(51) Int. Cl. G06Q 30/06; G06F 16/28; G09B 5/02; G09B 19/00

(52) U.S. Cl. CPC G06Q 30/0631; G09B 19/00; G09B 5/02; G06F 16/288

(57) ABSTRACT

A cocktail proposal apparatus according to the present disclosure includes an input unit configured to receive an input of a requirement for a cocktail, a correspondence relationship storage unit configured to store a first correspondence relationship representing a correspondence relationship between an element characterizing the cocktail and the cocktail, an optimum cocktail search unit configured to select a type of cocktail based on the element included in the requirement input to the input unit and the first correspondence relationship, and an output unit configured to output the type of cocktail selected by the optimum cocktail search unit.

### INCORPORATION BY REFERENCE

This application is based upon and claims the benefit of priority from Japanese patent application No. 2020-203907, filed on Dec. 9, 2020, the disclosure of which is incorporated herein in its entirety by reference.

### TECHNICAL FIELD

The present disclosure relates to a cocktail proposal apparatus, a cocktail proposal method, and a non-transitory computer readable medium.

### BACKGROUND ART

In related art, when a cocktail is served to a customer, the customer selects a cocktail from a fixed menu, and then a bartender makes and serves the cocktail selected by the customer.

However, there are a wide variety of types of cocktails, and many types of cocktails are not on menus.

Thus, it is considered that many customers may want to drink cocktails that are not on a menu.

However, it is considered that customers generally have little knowledge of cocktails and thus may have ambiguous requests for kinds of cocktails they want, such as a cocktail with a gentle taste or a cool cocktail.

In order to respond to such customers' ambiguous requests, even bartenders need to have a great deal of knowledge about cocktails.

However, as described above, since there are a wide variety of types of cocktails, it is difficult for bartenders to have a comprehensive knowledge about all this wide variety of types of cocktails.

Therefore, recently, in order to supplement the bartenders' knowledge, there has been a demand for a technique by which cocktails more precisely meeting ambiguous requests from customers can be proposed.

One of related art is Japanese Unexamined Patent Application Publication No. 2002-197162. According to the technique disclosed in Japanese Unexamined Patent Application Publication No. 2002-197162, when a customer inputs his/her budget and preference, a drink (e.g., wine) suited to the his/her budget and preference is selected and displayed.

As described above, according to the technique disclosed in Japanese Unexamined Patent Application Publication No. 2002-197162, it is possible to propose a drink suited to a customer's budget and preference.

However, the technique disclosed in Japanese Unexamined Patent Application Publication No. 2002-197162 proposes a drink based on a clear request such as a customer's budget and preference. It is therefore difficult for the technique disclosed in Japanese Unexamined Patent Application Publication No. 2002-197162 to propose a drink meeting a customer's request when the customer's request is ambiguous.

### SUMMARY

An object of the present disclosure is to provide a cocktail proposal apparatus, a cocktail proposal method, and a non-transitory computer readable medium capable of proposing a cocktail more precisely meeting an ambiguous request from a customer.

An example aspect of the present disclosure is a cocktail proposal apparatus includes:

an input unit configured to receive an input of a requirement for a cocktail;

a correspondence relationship storage unit configured to store a first correspondence relationship representing a correspondence relationship between an element characterizing the cocktail and the cocktail;

an optimum cocktail search unit configured to select a type of cocktail based on the element included in the requirement input to the input unit and the first correspondence relationship; and

an output unit configured to output the type of cocktail selected by the optimum cocktail search unit.

Another example aspect of the present disclosure is a cocktail proposal method performed by a cocktail proposal apparatus. The cocktail proposal method includes:

storing a first correspondence relationship representing a correspondence relationship between an element characterizing a cocktail and the cocktail;

receiving an input of a requirement for the cocktail;

selecting a type of cocktail based on the element included in the requirement input to the input unit and the first correspondence relationship; and

outputting the selected type of cocktail.

Another example aspect of the present disclosure is a non-transitory computer readable medium storing a program for causing a computer to execute:

a procedure of storing a first correspondence relationship representing a correspondence relationship between an element characterizing a cocktail and the cocktail;

a procedure of receiving an input of a requirement for the cocktail;

a procedure of selecting a type of cocktail based on the element included in the requirement input to the input unit and the first correspondence relationship; and

a procedure of outputting the selected type of cocktail.

### BRIEF DESCRIPTION OF DRAWINGS

The above and other aspects, characteristics, and advantages of the present disclosure will become more apparent from the following description of certain example embodiments when taken in conjunction with the accompanying drawings, in which:

FIG. 1 is a block diagram showing a configuration example of a cocktail proposal apparatus according to a first example embodiment;

FIG. 2 shows an example of cocktail characteristic correspondence relationships stored in a cocktail characteristic correspondence relationship storage unit according to the first example embodiment;

FIG. 3 shows an example of a cocktail model stored in a cocktail model storage unit according to the first example embodiment;

FIG. 4 shows an example of a cocktail making procedure stored in a cocktail making procedure storage unit according to the first example embodiment;

FIG. 5 shows an example of an input source terminal and an output destination terminal for the cocktail proposal apparatus according to the first example embodiment;

FIG. 6 shows an example of an input source terminal and an output destination terminal for the cocktail proposal apparatus according to the first example embodiment;

FIG. 7 shows an example of an input source terminal for the cocktail proposal apparatus according to the first example embodiment;

FIG. 8 is a flowchart for explaining an example of a schematic flow of an operation of the cocktail proposal apparatus according to the first example embodiment;

FIG. 9 is a flowchart for explaining an example of a schematic flow of an operation of Step S20 shown in FIG. 8;

FIG. 10 is a flowchart for explaining an example of a schematic flow of an operation of Step S30 shown in FIG. 8;

FIG. 11 is a diagram for explaining a specific example of the operation of Step S10 shown in FIG. 8;

FIG. 12 is a diagram for explaining a specific example of the operation of Step S20 shown in FIG. 8;

FIG. 13 is a diagram for explaining a specific example of the operation of Step S30 shown in FIG. 8;

FIG. 14 is a diagram for explaining a specific example of the operation of Step S40 shown in FIG. 8;

FIG. 15 is a diagram for explaining a specific example of the operation of Step S50 shown in FIG. 8;

FIG. 16 is a block diagram showing a configuration example of a cocktail proposal apparatus according to a second example embodiment; and

FIG. 17 is a block diagram showing a hardware configuration example of a cocktail proposal apparatus according to a third example embodiment.

### EXAMPLE EMBODIMENT

Example embodiments of the present disclosure will be described below with reference to the drawings. The following descriptions and drawings are omitted and simplified as appropriate for the purpose of clarifying the description. In the following drawings, the same elements are denoted by the same reference signs, and repeated descriptions thereof are omitted if necessary.

### First Example Embodiment

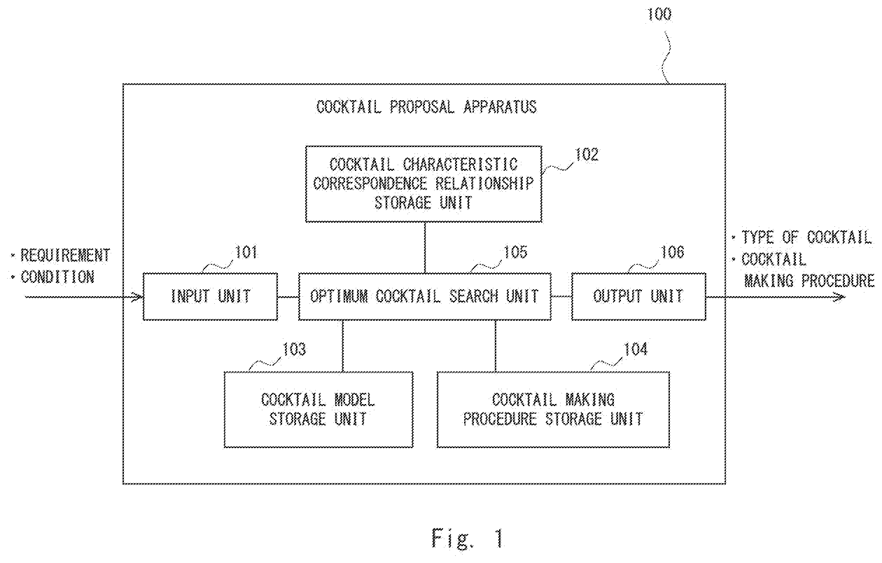

First, a configuration example of a cocktail proposal apparatus 100 according to a first example embodiment will be described with reference to FIG. 1. As shown in FIG. 1, the cocktail proposal apparatus 100 according to the first example embodiment includes an input unit 101, a cocktail characteristic correspondence relationship storage unit 102, a cocktail model storage unit 103, a cocktail making procedure storage unit 104, an optimum cocktail search unit 105, and an output unit 106.

The input unit 101 receives an input of requirements and conditions for cocktails. The requirements for cocktails include, for example, ingredients of the cocktail, a color of the cocktail, sensibility to describe the cocktail, an emotion to describe the cocktail, and so on. The conditions for cocktails include, for example, a price.

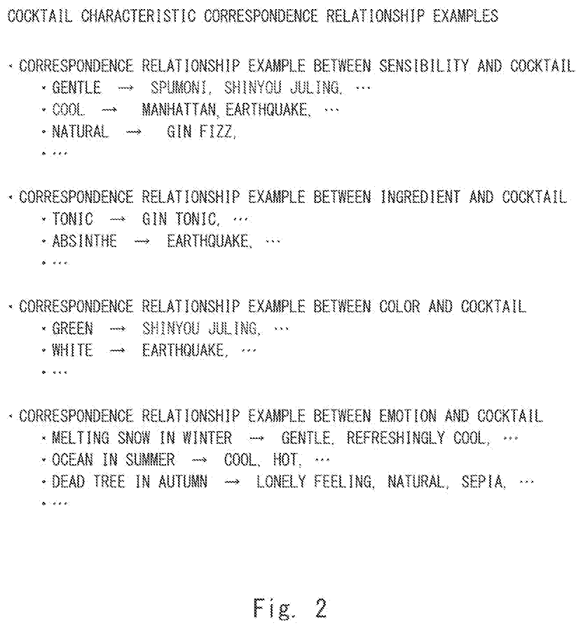

The cocktail characteristic correspondence relationship storage unit 102 stores cocktail characteristic correspondence relationships. The cocktail characteristic correspondence relationship includes a first correspondence relationship representing a correspondence relationship between an element characterizing a cocktail and a type of cocktail. In the first example embodiment, the cocktail characteristic correspondence relationship also includes a second correspondence relationship representing a correspondence relationship between the elements characterizing the cocktail. However, the cocktail characteristic correspondence relationship may or may not include the second correspondence relationship. Here, an example of the cocktail characteristic correspondence relationship including the first correspondence relationship and the second correspondence relationship stored in the cocktail characteristic correspondence relationship storage unit 102 will be described with reference to FIG. 2. In the example of FIG. 2, the cocktail characteristic correspondence relationship storage unit 102 stores, as the first correspondence relationship, for example, a correspondence relationship between the sensibility and type of cocktail, a correspondence relationship between the ingredients and type of cocktail, a correspondence relationship between the color and type of cocktail, and so on. In the example of FIG. 2, the cocktail characteristic correspondence relationship storage unit 102 stores, as the second correspondence relationship, for example, a correspondence relationship between the emotion and sensibility. That is, the examples shown in FIG. 2 is a diagram for conceptually and illustratively explaining data structures stored in the cocktail characteristic correspondence relationship storage unit 102. In the respective examples shown in FIG. 2, the items described on the right and left sides of the arrow represent data constituting the data structure and are related to each other (i.e., the aforementioned correspondence relationship).

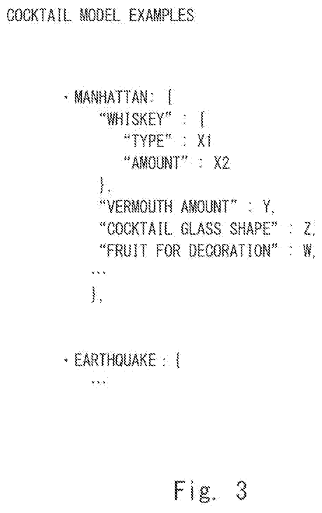

The cocktail model storage unit 103 stores, for each type of cocktail, a cocktail model of the cocktail including components of the cocktail model and undetermined variables. Referring now to FIG. 3, an example of the cocktail model stored in the cocktail model storage unit 103 will be described. In the example of FIG. 3, cocktail models such as Manhattan and Earthquake are stored in the cocktail model storage unit 103. For example, in the cocktail model of Manhattan, a type of whiskey X1, an amount of whiskey X2, an amount of vermouth Y, a cocktail glass shape Z, and fruit for decoration W are undetermined variables. That is, the example shown in FIG. 3 is a diagram for conceptually and illustratively explaining the data structure of the cocktail model stored in the cocktail model storage unit 103. The example of the cocktail model “Manhattan” shown in FIG. 3 shows that the aforementioned variables are associated with each other as the data constituting the data structure.

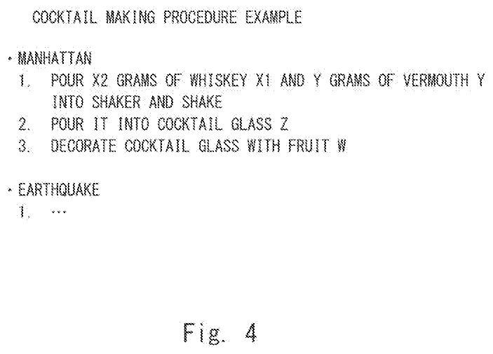

The cocktail making procedure storage unit 104 stores, for each type of cocktail, a cocktail making procedure of the cocktail including a constitution procedure of the cocktail making procedure and undetermined variables. Here, an example of the cocktail making procedure stored in the cocktail making procedure storage unit 104 will be described with reference to FIG. 4. In the example of FIG. 4, the cocktail making procedure storage unit 104 stores the cocktail making procedures of, for example, Manhattan and Earthquake. For example, in the cocktail making procedure for Manhattan, the type of whiskey X1, the amount of whiskey X2, the amount of vermouth Y, the cocktail glass shape Z, and the fruit for decoration W are undetermined variables. That is, the example shown in FIG. 4 is a diagram for conceptually and illustratively explaining the data structure of the cocktail making procedure stored in the cocktail making procedure storage unit 104. An example of the procedure for making the cocktail “Manhattan” shown in FIG. 4 shows that, as the data constituting the data structure, the procedures 1 to 3 shown in FIG. 4 represent the order and are related to each other in a state including the variables described with reference to FIG. 3.

As shown in FIGS. 3 and 4, the cocktail models and cocktail making procedures for the cocktails of the same type (in the example of FIGS. 3 and 4, Manhattan) include variables identical to each other as the undetermined variables.

The optimum cocktail search unit 105 first selects the type of cocktail based on elements included in the requirements input to the input unit 101 and the first correspondence relationship stored in the cocktail characteristic correspondence relationship storage unit 102. If the second correspondence relationship is stored in the cocktail characteristic correspondence relationship storage unit 102, the optimum cocktail search unit 105 may select the type of cocktail based on the elements included in the requirements input to the input unit 101 and the first and second correspondence relationships. Next, the optimum cocktail search unit 105 reads the cocktail model of the cocktail of the selected type from the cocktail model storage unit 103, and determines a value of each undetermined variable included in the read cocktail model based on the condition input to the input unit 101. Next, the optimum cocktail search unit 105 reads the cocktail making procedure of the cocktail of the selected type from the cocktail making procedure storage unit 104, and assigns the value of each variable included in the cocktail model determined above to each undetermined variable included in the read cocktail making procedure.

The output unit 106 outputs the type of cocktail selected by the optimum cocktail search unit 105, and also outputs the cocktail making procedure of the cocktail, in which the values are assigned to the variables by the optimum cocktail search unit 105.

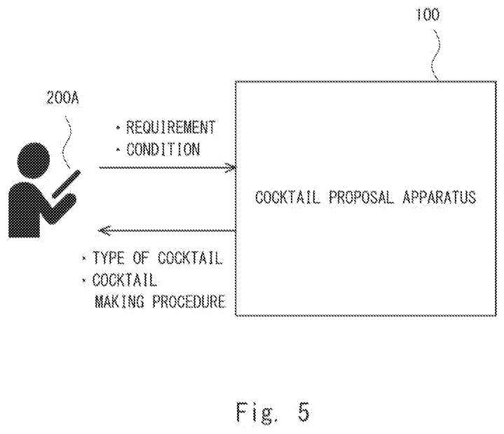

Next, examples of an input source terminal and an output destination terminal for the cocktail proposal apparatus 100 according to the first example embodiment will be described with reference to FIGS. 5 to 7.

In the example of FIG. 5, one terminal 200A is an input source terminal and also an output destination terminal.

For example, the terminal 200A is used by a customer who visits a shop serving cocktails. The use scene in this case is, for example, as follows. The customer inputs his/her requirements and conditions for the cocktail and obtains the output of the type of cocktail and the cocktail making procedure. The customer presents the output result to the bartender or hall staff, and the bartender cooks based on the output result.

Alternatively, the terminal 200A may be used by the bartender or hall staff working in the shop serving cocktails. The use scene in this case is, for example, as follows. The bartender or hall staff listens to the customer's requirements and conditions for the cocktail, inputs the customer's requirements and conditions, and obtains the output of the type of cocktail and the cocktail making procedure. The bartender cooks based on the output result. There may also be requests from shops to use leftover ingredients. Thus, the bartender or hall staff may input additional shop requirements and conditions for cocktails.

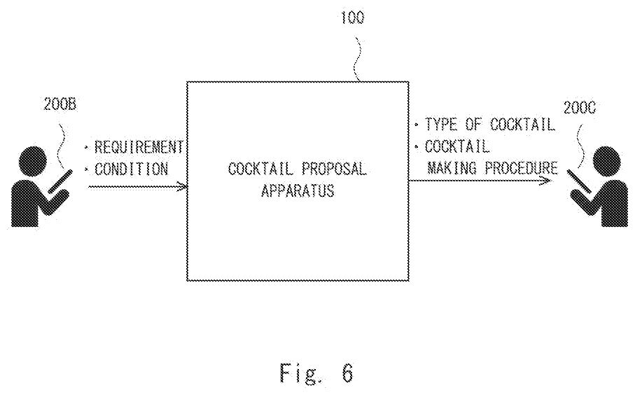

In the example of FIG. 6, one terminal 200B is an input source terminal, and another terminal 200C different from the terminal 200B is an output destination terminal.

For example, the terminal 200B is used by a customer who comes to a shop serving cocktails, and the terminal 200C is used by a bartender or hall staff working at the shop. The use scene in this case is, for example, as follows. The customer inputs the customer's requirements and conditions for the cocktail. The bartender or hall staff obtains the output of the type of cocktail and the cocktail making procedure, and the bartender cooks based on the output result.

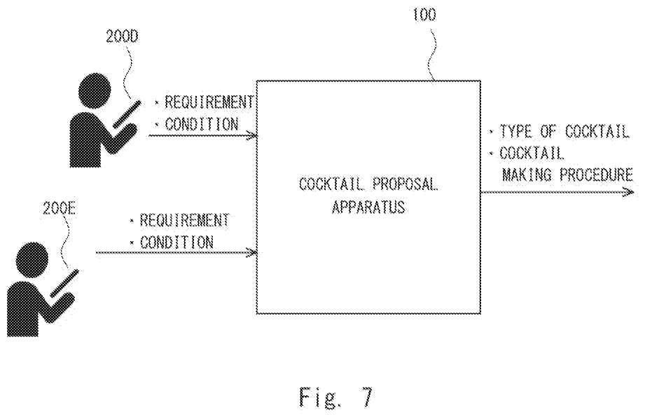

In the example of FIG. 7, a plurality of (in FIG. 7, two) terminals 200D and 200E are input source terminals.

For example, the terminal 200D is used by a customer who comes to a shop serving cocktails, and the terminal 200E is used by a bartender or hall staff working at the shop. The use scene in this case is, for example, as follows. The customer inputs the customer's requirements and conditions for the cocktail. The bartender or hall staff also inputs the shop's requirements and conditions for the cocktail.

In the example of FIG. 7, although the output destination terminal is not shown, the output destination terminal may be any terminal. For example, the output destination terminal may be one or both of the terminals 200D and 200E, or may be any one or more terminals other than the terminals 200D and 200E.

Note that the terminals 200A to 200E shown in FIGS. 5 to 7 may have at least an input function, a communication function, and a display function. The terminals 200A to 200E shown in FIGS. 5 to 7 are portable terminals, and instead may be stationary fixed terminals.

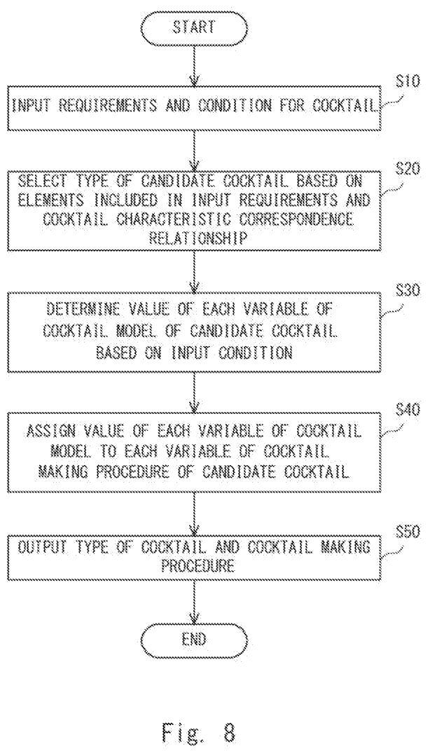

Next, an example of a flow of a schematic operation of the cocktail proposal apparatus 100 according to the first example embodiment will be described with reference to FIG. 8. When the flow of FIG. 8 is started, it is assumed that the cocktail characteristic correspondence relationship storage unit 102 stores the cocktail characteristic correspondence relationships including the first correspondence relationship and the second correspondence relationship, the cocktail model storage unit 103 stores the cocktail models, and the cocktail making procedure storage unit 104 stores the cocktail making procedures.

As shown in FIG. 8, first, the requirements and conditions for cocktails are input to the input unit 101 (Step S10).

Next, the optimum cocktail search unit 105 selects a type of candidate cocktail based on the elements included in the requirements input to the input unit 101 in Step S10 and the first and second correspondence relationships stored in the cocktail characteristic correspondence relationship storage unit 102 (Step S20).

Next, the optimum cocktail search unit 105 reads the cocktail model of the candidate cocktail selected in Step S20 from the cocktail model storage unit 103, and determines the value of each undetermined variable included in the read cocktail model based on the condition input to the input unit 101 (Step S30).

Next, the optimum cocktail search unit 105 reads the cocktail making procedure of the candidate cocktail selected in Step S20 from the cocktail making procedure storage unit 104, and assigns the values of the variables determined in Step S30 and included in the cocktail model to the undetermined variables included in the read cocktail making procedure (Step S40).

After that, the output unit 106 outputs the type of cocktail selected by the optimum cocktail search unit 105 in Step S20, and also outputs the cocktail making procedure of the cocktail, in which the optimum cocktail search unit 105 assigns values to the respective variables in Step S40 (Step S50).

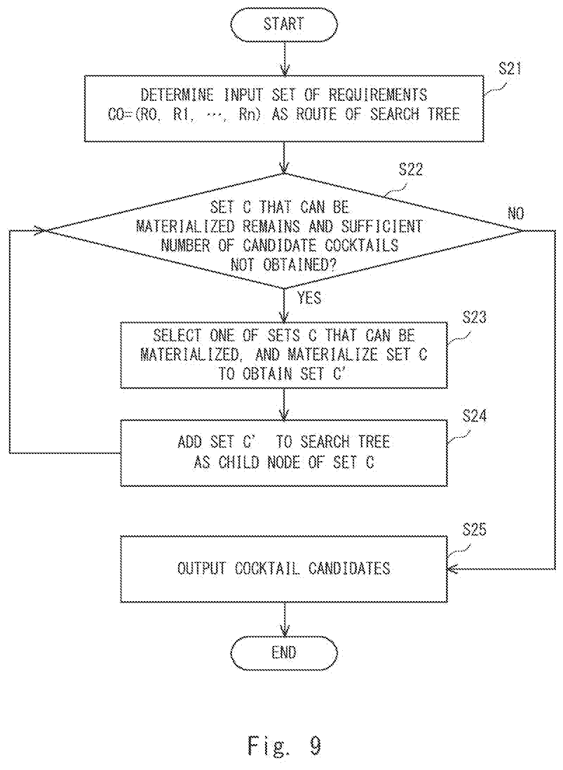

Next, an example of the flow of the schematic operation in Step S20 shown in FIG. 8 will be described with reference to FIG. 9. In FIG. 9, a set of requirements for cocktails is indicated by a symbol C, and in particular, a set of requirements for cocktails input to the input unit 101 is indicated by a symbol CO.

As shown in FIG. 9, first, the optimum cocktail search unit 105 determines the set of requirements C0=(R0, R1, . . . , Rn) input to the input unit 101 as a route of a search tree (Step S21). The search tree has a set of requirements as nodes.

Next, the optimum cocktail search unit 105 determines whether or not the condition “There still remains a set C that can be materialized and a sufficient number of candidate cocktails has not been obtained” is satisfied (Step S22). Here, the “sufficient number” is predetermined.

If the conditions described above are satisfied in Step S22 (YES in Step S22), the optimum cocktail search unit 105 selects one of the sets C that can be materialized, and materializes the set C based on the first correspondence relationship and the second correspondence relationship stored in the cocktail characteristic correspondence relationship storage unit 102 to obtain a set C′ (Step S23). In Step S23, the optimum cocktail search unit 105 creates the set C′ by materializing the set C based on the first correspondence relationship and the second correspondence relationship.

Next, the optimum cocktail search unit 105 adds the set C′ to the search tree as a child node of the set C selected in Step S23 (Step S24). The set C added to the search tree is one of the candidate cocktails. After Step S24, the optimum cocktail search unit 105 returns to Step S22 and repeats the processing from Step S22.

If the condition “There still remains a set C that can be materialized and a sufficient number of candidate cocktails has not been obtained” is not satisfied in Step S22 (NO in Step S22), the optimum cocktail search unit 105 outputs the types of cocktail candidates obtained so far (Step S25), and the processing ends.

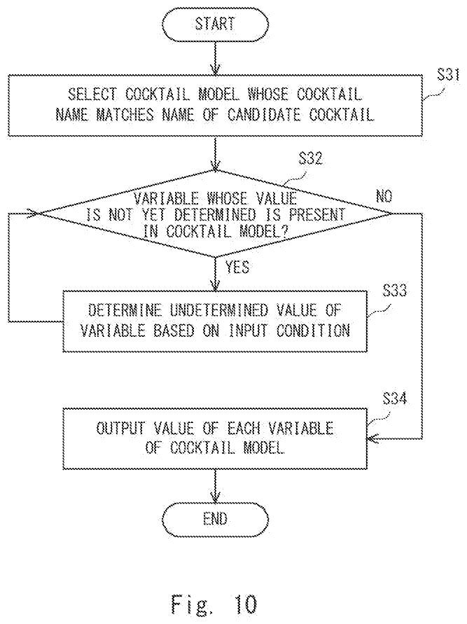

Next, an example of the flow of the schematic operation in Step S30 shown in FIG. 8 will be described with reference to FIG. 10. The flow shown in FIG. 10 is performed for each candidate cocktail. For example, if there are two candidate cocktails, Manhattan and Earthquake, the flow shown in FIG. 10 is performed for each Manhattan and Earthquake.

As shown in FIG. 10, first, the optimum cocktail search unit 105 selects a cocktail model whose cocktail name matches a name of the candidate cocktail from among the cocktail models stored in the cocktail model storage unit 103, and reads the selected cocktail model from the cocktail model storage unit 103 (Step S31).

Next, the optimum cocktail search unit 105 determines whether a variable whose value is not yet determined is present in the variables included in the cocktail model read in Step S31 (Step S32).

In Step S32, if there is a variable whose value is not yet determined (YES in Step S32), the optimum cocktail search unit 105 determines the undetermined value of each variable included in the cocktail model based on the condition input to the input unit 101 (Step S33). After Step S33, the optimum cocktail search unit 105 returns to Step S32 and repeats the processing from Step S32.

If there is no variable whose value is not yet determined in Step S32 (NO in Step S32), the optimum cocktail search unit 105 outputs the determined value of each variable of the cocktail model (Step S34), and the processing ends.

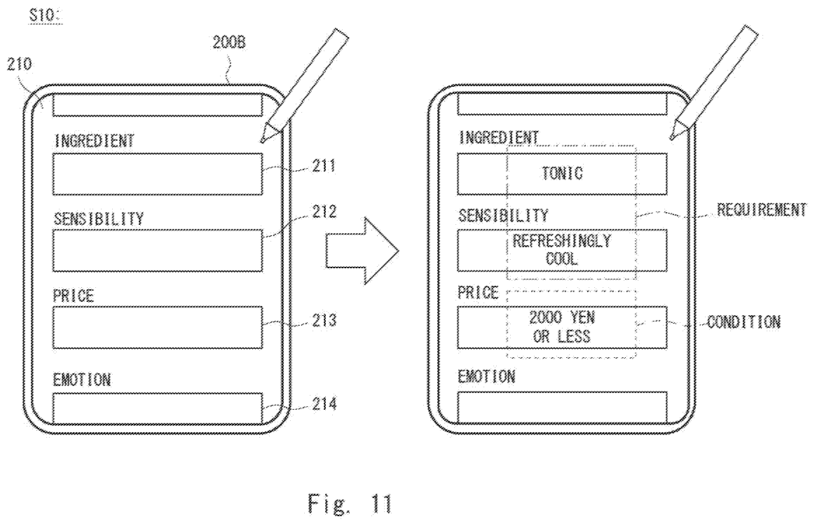

Next, specific examples of operations of Steps S10 to S50 shown in FIG. 8 will be described with reference to FIGS. 11 to 15. In FIGS. 11 to 15, it is assumed that an input source terminal is the terminal 200B and an output destination terminal is the terminal 200C (see FIG. 6). The terminal 200B is used by the customer, and the terminal 200C is used by the bartender.

### Step S10:

First, a specific example of the operation of Step S10 shown in FIG. 8 will be described with reference to FIG. 11.

As shown in FIG. 11, the input unit 101 displays an input screen 210 for inputting the requirements and condition for a cocktail on a display of the terminal 200B. The input screen 210 includes areas 211 to 214. The area 211 is for inputting the ingredients of the cocktail, the area 212 is for inputting the sensibility to describe the cocktail, the area 213 is for inputting the amount of the cocktail, and the area 214 is for inputting the emotion to describe the cocktail. The input screen 210 also includes other areas, which can be displayed by scrolling up and down.

The customer inputs text data in an optional area among the areas 211 to 214 included in the input screen 210. In the example of FIG. 11, input by a touch pen or the like is assumed. Alternatively, the text data may be input by any method such as keyboard input.

In the example of FIG. 11, the customer inputs the ingredient “tonic” in the area 211, the sensibility “refreshingly cool” in the area 212, and the price “2000 yen or less” in the area 213. Among them, the ingredient “tonic” and the sensibility “refreshingly cool” are the elements which constitute the requirements for the cocktail, and the price “2000 yen or less” is the condition for the cocktail. For each area, it is predetermined whether the text data input to the area is a requirement, a condition, or both a requirement and a condition.

### Step S20:

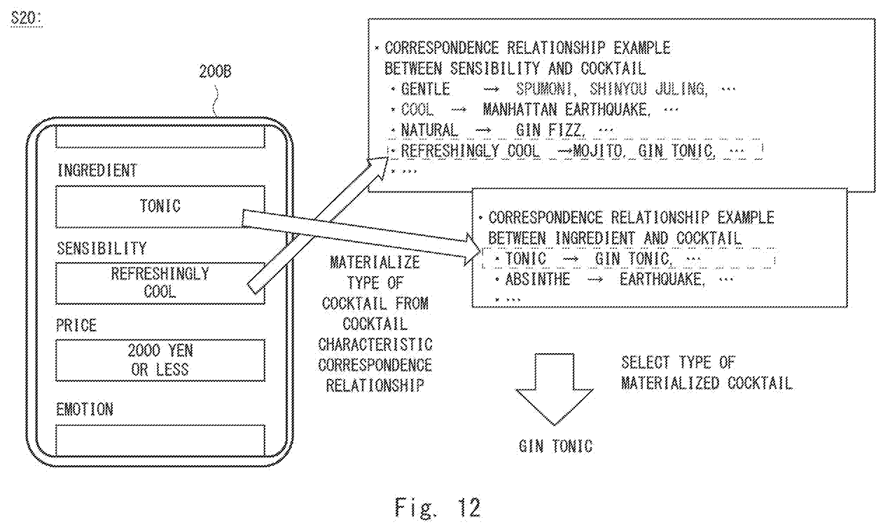

Next, a specific example of the operation of Step S20 shown in FIG. 8 will be described with reference to FIG. 12.

As shown in FIG. 12, the optimum cocktail search unit 105 materializes the types of candidate cocktails based on the ingredient “tonic” and the sensibility “refreshingly cool” input to the input unit 101 as the requirements in Step S10 and the first correspondence relationship and the second correspondence relationship stored in the cocktail characteristic correspondence relationship storage unit 102.

In the example shown in FIG. 12, the cocktail characteristic correspondence relationship storage unit 102 stores, as the first correspondence relationship, the correspondence relationship between the sensibility and the type of cocktail, and the correspondence relationship between the ingredient and the type of cocktail. According to this, the types of cocktail corresponding to the sensibility “refreshingly cool” are “mojito” and “gin and tonic” and the type of cocktail corresponding to the ingredient “tonic” is “gin and tonic.

For this reason, the optimum cocktail search unit 105 materializes the ingredient “tonic” and the sensibility “refreshingly cool” input to the input unit 101 as the requirements into “gin tonic”, and selects the materialized “gin tonic” as the type of candidate cocktail.

### Step S30:

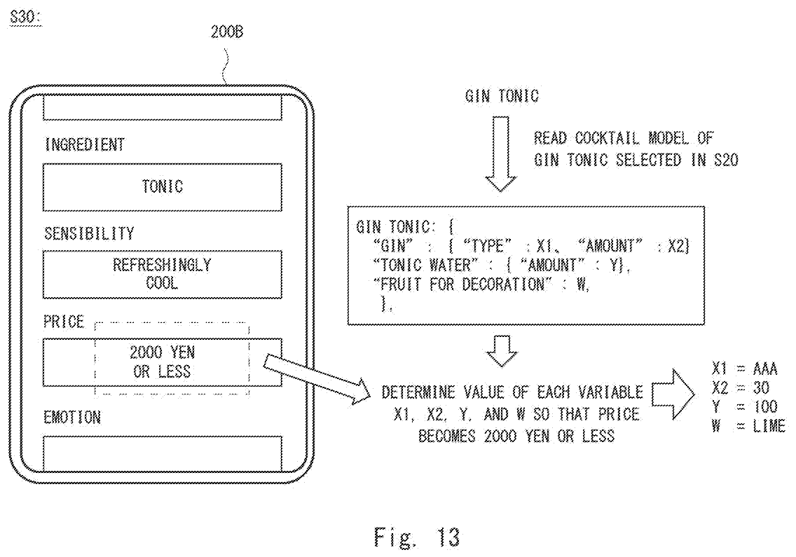

Next, a specific example of the operation of Step S30 shown in FIG. 8 will be described referring to FIG. 13.

As shown in FIG. 13, first, the optimum cocktail search unit 105 reads the cocktail model of “gin and tonic” selected in Step S20 from the cocktail model storage unit 103.

In the example of FIG. 13, in the cocktail model of “gin and tonic”, the type of gin X1, the amount of gin X2, the amount of tonic water Y, and the fruit for decoration W are variables whose values are not yet determined.

Thus, the optimum cocktail search unit 105 determines the values of the variables X1, X2, Y, and W so as to satisfy the price “2000 yen or less” input to the input unit 101 as a condition, that is, so that the gin tonic served to the customer becomes 2000 yen or less. Specifically, in the example of FIG. 13, the type of gin X1 is determined to be “AAA”, the amount of gin X2 is determined to be “30 grams”, the amount of tonic water Y is determined to be “100 grams”, and the fruit for decoration W is determined to be “lime”.

### Step S40:

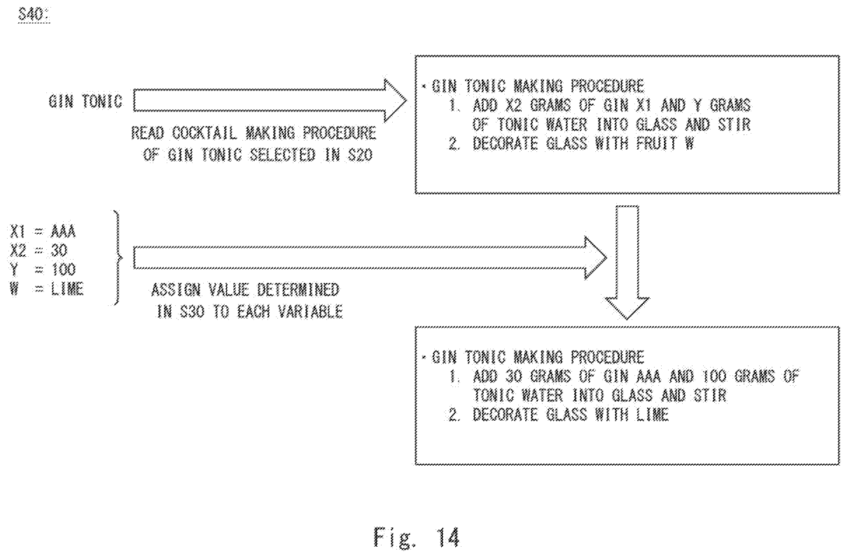

Next, a specific example of the operation of Step S40 shown in FIG. 8 will be described with reference to FIG. 14.

As shown in FIG. 14, first, the optimum cocktail search unit 105 reads the cocktail making procedure of the “gin and tonic” selected in Step S20 from the cocktail making procedure storage unit 104.

In the example of FIG. 14, variables X1, X2, Y, and W are variables whose values are not yet determined in the cocktail making procedure of “gin and tonic” as in the cocktail model of “gin and tonic”. However, the values of the variables X1, X2, Y, and W are determined in Step S30.

Thus, the optimum cocktail search unit 105 assigns the values of the variables X1, X2, Y, and W determined in Step S30 for the cocktail model of the “gin tonic” to the variables X1, X2, Y, and W included in the cocktail making procedure of the “gin tonic”. Specifically, in the example of FIG. 14, “AAA” is assigned to the variable X1, “30 grams” is assigned to the variable X2, “100 grams” is assigned to the variable Y, and “lime” is assigned to the variable W.

### Step S50:

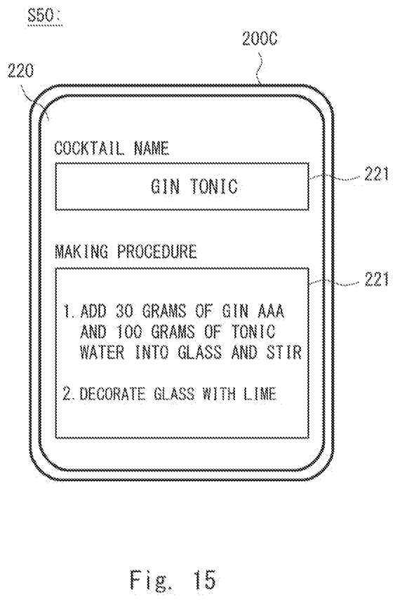

Next, a specific example of the operation of Step S50 shown in FIG. 8 will be described with reference to FIG. 15.

As shown in FIG. 15, the output unit 106 causes the display of the terminal 200C to display an output screen 220 for displaying the type of cocktail and the cocktail making procedure to be proposed to the bartender. The output screen 220 includes areas 221 and 222. The area 221 is for displaying the type of cocktail to be proposed to the bartender, and the area 222 is for displaying the cocktail making procedure of the cocktail to be proposed to the bartender. The output screen 220 may include other areas, and the other areas may be displayed by scrolling up and down.

In the example of FIG. 15, the area 221 displays the name of the “gin tonic” to be proposed to the bartender, and the area 222 displays the procedure for making “gin tonic” proposed to the bartender.

As described above, according to the first example embodiment, the cocktail characteristic correspondence relationship storage unit 102 stores the first correspondence relationship representing the correspondence relationship between the elements characterizing a cocktail and the type of cocktail. The optimum cocktail search unit 105 selects the type of cocktail based on the elements included in the requirements input to the input unit 101 and the first correspondence relationship. The output unit 106 outputs the selected type of cocktail. Thus, even if the requirement input to the input unit 101 is ambiguous, the type of cocktail can be selected by materializing the input requirements using the first correspondence relationship. Therefore, a cocktail which meets the ambiguous request from the customer more precisely can be proposed.

According to the first example embodiment, the cocktail model storage unit 103 stores the cocktail models each including the variables for each type of cocktail, and the cocktail making procedure storage unit 104 stores the cocktail making procedures each including the variables for each type of cocktail. The optimum cocktail search unit 105 determines the value of the variable included in the cocktail model of the selected cocktail based on the condition input to the input unit 101. The optimum cocktail search unit 105 assigns the determined values of the variables included in the cocktail model to the variables included in the selected cocktail making procedure. The output unit 106 outputs the cocktail making procedure of the selected cocktail in which the determined values are assigned to the variables. In this manner, it is possible to not only propose the cocktail and the cocktail making procedure of that cocktail. At this time, instead of outputting the cocktail making procedure stored in the cocktail making procedure storage unit 104 as it is, the variables included in the cocktail making procedure are optimized based on the condition input to the input unit 101, and the cocktail making procedure in which the variables are optimized is output. In this way, the cocktail making procedure more precisely meeting the customer's request can be proposed.

Further, according to the first example embodiment, the cocktail characteristic correspondence relationship storage unit 102 may further store the second correspondence relationship representing the correspondence relationship between the elements characterizing the cocktail. The optimum cocktail search unit 105 may select the type of cocktail based on the elements included in the requirements input to the input unit 101 and the first and second correspondence relationships. This makes it easier to materialize the input requirements, thereby facilitating selection of the type of cocktail.

### Second Example Embodiment

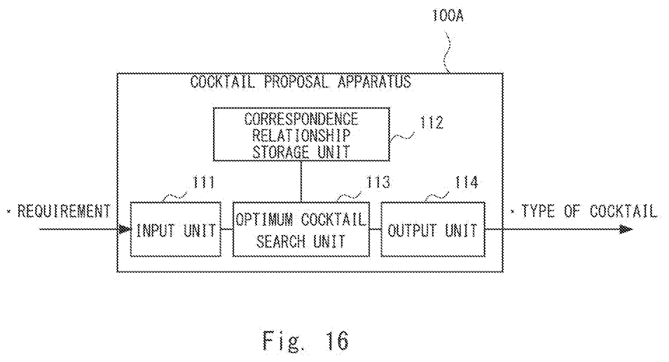

A configuration example of a cocktail proposal apparatus 100A according to a second example embodiment will be described with reference to FIG. 16. As shown in FIG. 16, the cocktail proposal apparatus 100A according to the second example embodiment includes an input unit 111, a correspondence relationship storage unit 112, an optimum cocktail search unit 113, and an output unit 114.

The input unit 111 receives an input of requirements for cocktails. The input unit 111 corresponds to, for example, the input unit 101.

The correspondence relationship storage unit 112 stores a first correspondence relationship representing a correspondence relationship between elements characterizing a cocktail and the cocktail. The correspondence relationship storage unit 112 corresponds to, for example, the cocktail characteristic correspondence relationship storage unit 102.

The optimum cocktail search unit 113 selects a type of cocktail based on elements included in requirements input to the input unit 111 and a first correspondence relationship stored in the correspondence relationship storage unit 112. The optimum cocktail search unit 113 corresponds to, for example, the optimum cocktail search unit 105.

The output unit 114 outputs the type of cocktail selected by the optimum cocktail search unit 113. The output unit 114 corresponds to, for example, the output unit 106.

Thus, even if the requirement input to the input unit 111 is ambiguous, the type of cocktail can be selected by materializing the input requirements using the first correspondence relationship. Therefore, a cocktail which more precisely meets the ambiguous request from the customer can be proposed.

The cocktail proposal apparatus 100A according to the second example embodiment may further include a cocktail model storage unit for storing cocktail models each including variables for each type of cocktail, and a cocktail making procedure storage unit for storing cocktail making procedures each including variables for each type of cocktail. The cocktail model storage unit and the cocktail making procedure storage unit correspond to, for example, the cocktail model storage unit 103 and the cocktail making procedure storage unit 104, respectively. The input unit 111 may further receive an input of conditions for cocktails. The optimum cocktail search unit 113 may determine the values of the variables included in the cocktail model of the selected cocktail based on the condition input to the input unit 111, and assign the determined values of the variables included in the cocktail model to the variables included in the cocktail making procedure of the selected cocktail. The output unit 114 may further output the cocktail making procedure after the optimum cocktail search unit 113 assigns the values to the variables.

Further, the cocktail characteristic correspondence relationship storage unit 112 may further store the second correspondence relationship representing the correspondence relationship between the elements characterizing the cocktail. Furthermore, the optimum cocktail search unit 113 may select the type of cocktail based on the elements included in the requirements input to the input unit 111 and the first and second correspondence relationships stored in the correspondence relationship storage unit 112.

In addition, the optimum cocktail search unit 113 may select a predetermined number of cocktails and assign values to the variables included in the cocktail making procedure for each selected cocktail. The output unit 114 may output the predetermined number of types of cocktails selected by the optimum cocktail search unit 113, and may also output the cocktail making procedure for each selected type of cocktail after the optimum cocktail search unit 113 assigns the values to the variables.

Further, the input unit 111 may receive an input of the requirements and conditions for cocktails from a plurality of input sources.

### Third Example Embodiment

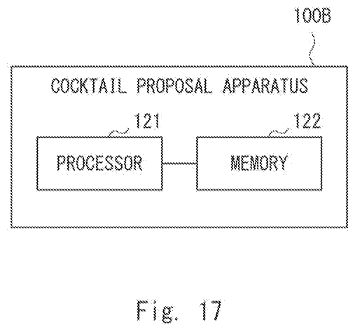

A hardware configuration example of a cocktail proposal apparatus 100B according to a third example embodiment will be described with reference to FIG. 17. As shown in FIG. 17, the cocktail proposal apparatus 100B according to the third example embodiment includes a processor 121 and a memory 122.

The processor 121 may be, for example, a microprocessor, an MPU (Micro Processing Unit), or a CPU (Central Processing Unit). The processor 121 may include a plurality of processors.

The memory 122 is composed of a combination of a volatile memory and a non-volatile memory. The memory 122 may include storage separated from the processor 121. In this case, the processor 121 may access the memory 122 via an I (Input)/O (Output) interface (not shown).

Each of the cocktail proposal apparatuses 100 and 100A according to the first and second example embodiments, respectively, may have a hardware configuration shown in FIG. 17. The input unit 101, the optimum cocktail search unit 105, and the output unit 106 in the above-described cocktail proposal apparatus 100, and the input unit 111, the optimum cocktail search unit 113, and the output unit 114 in the above-described cocktail proposal apparatus 100A may be realized by the processor 121 reading and executing programs stored in the memory 122. Further, the cocktail characteristic correspondence relationship storage unit 102, the cocktail model storage unit 103, and the cocktail making procedure storage unit 104 in the cocktail proposal apparatus 100, and the correspondence relationship storage unit 112 in the cocktail proposal apparatus 100A may be realized by the memory 122.

The above-mentioned program can be stored and provided to a computer (including a computer 50) using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Compact Disc-ROM), CD-R (CD-Recordable), CD-R/W (CD-ReWritable), and semiconductor memories (such as mask ROM, PROM (Programmable ROM), EPROM (Erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Although the present disclosure has been described above with reference to the example embodiments, the present disclosure is not limited to the example embodiments described above. The configuration and details of the present disclosure may be modified in various ways that would be understood by those skilled in the art within the scope of the present disclosure.

For example, in the example embodiments described above, a scene used by a customer, a bartender, or a hall staff in a shop serving cocktails has been described as an example of a use scene of the present disclosure. However, the present disclosure is not limited to this. The disclosure may be used, for example, by a general user when he or she is shopping for alcohol, or by an employee of an alcohol sales company for marketing purposes.

What is claimed is:

1. A cocktail proposal apparatus comprising:
an input unit configured to receive an input of a requirement for a cocktail;
a correspondence relationship storage unit configured to store a first correspondence relationship representing a correspondence relationship between an element characterizing the cocktail and the cocktail;
an optimum cocktail search unit configured to select a type of cocktail based on the element included in the requirement input to the input unit and the first correspondence relationship; and
an output unit configured to output the type of cocktail selected by the optimum cocktail search unit.

2. The cocktail proposal apparatus according to claim 1, further comprising:
a cocktail model storage unit configured to store a cocktail model including a variable for each type of cocktail; and
a cocktail making procedure storage unit configured to store a cocktail making procedure including a variable for each type of cocktail, wherein
the input unit is further configured to receive an input of a condition for the cocktail,
the optimum cocktail search unit is configured to determine a value of the variable included in the cocktail model of the selected type of cocktail based on the condition input to the input unit, and assigns the determined value of the variable included in the cocktail model to the variable included in the cocktail making procedure of the selected type of cocktail, and
the output unit is configured to further output the cocktail making procedure after the optimum cocktail search unit has assigned the value to the variable.

3. The cocktail proposal apparatus according to claim 2, wherein
the correspondence relationship storage unit is configured to further store a second correspondence relationship representing a correspondence relationship between the elements characterizing the cocktail, and
the optimum cocktail search unit is configured to select the type of cocktail based on the element included in the requirement input to the input unit, the first correspondence relationship, and the second correspondence relationship.

4. The cocktail proposal apparatus according to claim 2, wherein
the optimum cocktail search unit is configured to select a predetermined number of types of cocktail and assign the value to the variable included in the cocktail making procedure for each selected type of cocktail, and
the output unit is configured to output the predetermined number of types of cocktail selected by the optimum cocktail search unit, and output the cocktail making procedure of each selected type of cocktail after the value is assigned to the variable by the optimum cocktail search unit.

5. The cocktail proposal apparatus according to claim 2, wherein
the input unit is configured to receive the input of the requirement and condition for cocktail from a plurality of input sources.

6. A cocktail proposal method performed by a cocktail proposal apparatus, the cocktail proposal method comprising:
storing a first correspondence relationship representing a correspondence relationship between an element characterizing a cocktail and the cocktail;
receiving an input of a requirement for the cocktail;
selecting a type of cocktail based on the element included in the requirement input to the input unit and the first correspondence relationship; and
outputting the selected type of cocktail.

7. A non-transitory computer readable medium storing a program for causing a computer to execute:
a procedure of storing a first correspondence relationship representing a correspondence relationship between an element characterizing a cocktail and the cocktail;
a procedure of receiving an input of a requirement for the cocktail;
a procedure of selecting a type of cocktail based on the element included in the requirement input to the input unit and the first correspondence relationship; and
a procedure of outputting the selected type of cocktail.
